(19) United States
(12) Patent Application Publication
(10) Pub. No.: US 2015/0285416 A1
(43) Pub. Date: Oct. 8, 2015

(54) METHOD OF MANUFACTURING OR REPAIRING A PIPE

(71) Applicant: AIRBUS OPERATIONS LIMITED, Bristol (GB)

(72) Inventor: Naresh Vaghela, Bristol (GB)

(21) Appl. No.: 14/435,926

(22) PCT Filed: Oct. 16, 2013
(86) PCT No.: PCT/GB2013/052697

§ 371 Date: Apr. 15, 2015

(30) Foreign Application Priority Data
Oct. 18, 2012 (GB) 1218754.8

(51) Int. Cl. F16L 21/035; B29D 23/00

(52) U.S. Cl. CPC F16L 21/035; B29D 23/003

(57) ABSTRACT

A method of manufacturing or repairing a pipe including: providing a pipe portion having a channel running along a surface of the pipe portion, wherein the channel has an internal surface; placing a filler material against the internal surface of the channel, and removing some of the filler material to provide a groove in the channel.

### BACKGROUND OF THE INVENTION

The present invention concerns manufacturing or repairing a pipe. More particularly, but not exclusively, this invention concerns a method of manufacturing or repairing a pipe where the pipe has a groove running along a surface of the pipe, the groove being for accommodating an O-ring seal. The invention also concerns a pipe or pipe portion.

Metallic pipes with O-ring grooves are traditionally manufactured with a separate end fitting. The end fitting may have a larger diameter than the rest of the pipe. The O-ring groove is machined out of the end fitting and is smoothed to give a good surface finish. It is possible to achieve a good surface finish in the metallic pipe. A rubber O-ring is then placed in the groove.

However, in order to save weight, especially on an aircraft, composite materials are increasingly being used. Composite material pipes can be manufactured using filament windings. A problem with using composite material pipes is that it is difficult to achieve a good surface finish in a machined O-ring groove. This causes the O-ring, especially if it is made from a compressive material such as rubber, to become damaged from the exposed composite fibres and surface roughness in the groove.

The present invention seeks to mitigate the above-mentioned problems. Alternatively or additionally, the present invention seeks to provide an improved method of manufacturing or repairing a pipe and an improved pipe or pipe portion.

### SUMMARY OF THE INVENTION

The present invention provides, according to a first aspect, a method of manufacturing or repairing a pipe, the method comprising the steps of providing a pipe portion, the pipe portion having a channel running along a surface of the pipe portion, the channel having an internal surface, placing a filler material against the internal surface of the channel, and removing some of the filler material to provide a groove inside the channel of the pipe portion.

Using a filler material allows the provided groove to have a good surface finish, as the filler material can be more easily finished than, for example, a composite material that may be used for the pipe portion.

Here, pipe portion may refer to a partial portion of a whole pipe or it may refer to the whole pipe itself.

Preferably, the channel extends at least partly around a circumference of the pipe portion. This allows the groove to be used for an O-ring. The channel may be internal or external to the pipe portion.

More preferably, the groove inside the channel is for accommodating an O-ring.

Preferably, the pipe portion is made from composite material. Alternatively, the method could also be used with metallic pipe portions. Here, a filler material with suitable bonding capability to metal would be used.

More preferably, the composite material pipe portion is made using filament winding.

Preferably, the pipe portion comprises an end fitting having a larger external diameter than a non-end region of the pipe and wherein the end fitting is integral with the pipe portion. Having an integral end fitting makes manufacture of the pipe portion, especially if the pipe portion is made of composite material, easier as it can be made in one step. For example, the end fitting could be filament wound in the same way as the rest of the pipe portion.

More preferably, the channel of the pipe portion may be located on the end fitting. Even more preferably, the pipe portion may comprise the end fitting only. Hence, the pipe portion/end fitting having the channel may have a larger diameter than the rest of the pipe to which the pipe portion/end fitting will be joined. Alternatively, the end fitting may be a separate component of the pipe or pipe portion.

Preferably, the filler material is a curable material and wherein, after the filler material is placed against the internal surface of the channel, the filler material is cured. This makes filling of the channel with the filler material easier, whilst still providing a filler material with sufficient strength.

Preferably, the filler material is a resin, for example an adhesive resin, for example epoxy resin. Alternatively, the filler material can be any suitable material that has the required strength, bonding capability to the material of the pipe portion and ability to be finished to a good surface finish, for example by grinding.

Preferably, enough filler material is used so as to substantially cover the entire internal surface of the channel. This allows a good surface finish to be provided over the entire internal surface of the channel.

More preferably, enough filler material is used so as to fill the channel substantially completely.

Preferably, at least some of the filler material that is removed is removed by machining, for example by grinding. Alternatively, it may be removed by acid “etching” or any other suitable method.

Preferably, the method further comprises the step of providing an O-ring in the groove.

Preferably, the channel has a diameter between 2 and 6 mm.

Preferably, the channel has inwardly angled edges. This helps to retain the filler material in the channel. It also provides a larger adhesion area for the resin, compared to straight vertical edges, for example.

Preferably, after removal of the filler material, the remaining filler material has a thickness of less than 1 mm, for example between 0.25 and 0.5 mm.

The present invention provides, also according to a first aspect, a pipe manufactured or repaired as described above.

The present invention provides, also according to a first aspect, a pipe portion having a channel running along an external surface of the pipe portion, the channel having an internal surface, a layer of filler material placed against the internal surface of the channel, and a groove provided by the layer of filler material inside the channel of the pipe portion.

The present invention provides, also according to a first aspect, a pipe comprising the pipe portion described above.

Preferably, the pipe or pipe portion is for use on an aircraft, for example, in an aircraft fuel, pneumatic or inerting system.

The present invention provides, also according to a first aspect, an aircraft comprising a pipe or pipe portion described above.

According to a second aspect of the invention there is also provided a method of manufacturing or repairing a pipe, the method comprising the step of providing a pipe portion, the pipe portion being made from composite material, and the pipe portion comprising an end fitting having a larger external diameter than a non-end region of the pipe portion and wherein the end fitting is integral with the non-end region of the pipe portion.

Having an integral end fitting makes manufacture of the composite material pipe portion easier as it can be made in one step.

Preferably, the composite material pipe portion comprising the end fitting is made using filament winding. This allows the end fitting to be filament wound in the same way as the rest of the pipe portion.

The present invention provides, also according to a second aspect, a pipe manufactured or repaired according to the method described above.

The present invention provides, also according to a second aspect, a pipe portion made from composite material, wherein the pipe portion comprises an end fitting having a larger external diameter than a non-end region of the pipe portion and wherein the end fitting is integral with the non-end region of the pipe portion.

Preferably, the composite material pipe portion is made using filament winding.

The present invention provides, also according to a second aspect, a pipe comprising the pipe portion described above.

Preferably, the pipe or pipe portion is for use on an aircraft, for example, in an aircraft fuel, pneumatic or inerting system.

The present invention provides, also according to a second aspect, an aircraft comprising a pipe or pipe portion described above.

It will of course be appreciated that features described in relation to one aspect of the present invention may be incorporated into other aspects of the present invention. For example, any of the methods of the invention may incorporate any of the features described with reference to any of the apparatus of the invention or any of the other methods of the invention and vice versa.

### DESCRIPTION OF THE DRAWINGS

Embodiments of the present invention will now be described by way of example only with reference to the accompanying schematic drawings of which:

FIG. 1 shows a side view of a portion of a pipe according to a first embodiment of the invention;

FIG. 2a shows an enlarged cross-sectional view of the channel of the pipe portion of FIG. 1, when the channel is filled with resin; and

FIG. 2b shows an enlarged cross-sectional view of the channel of the pipe portion of FIG. 1, when the resin has been partly ground down to leave an O-ring groove.

### DETAILED DESCRIPTION

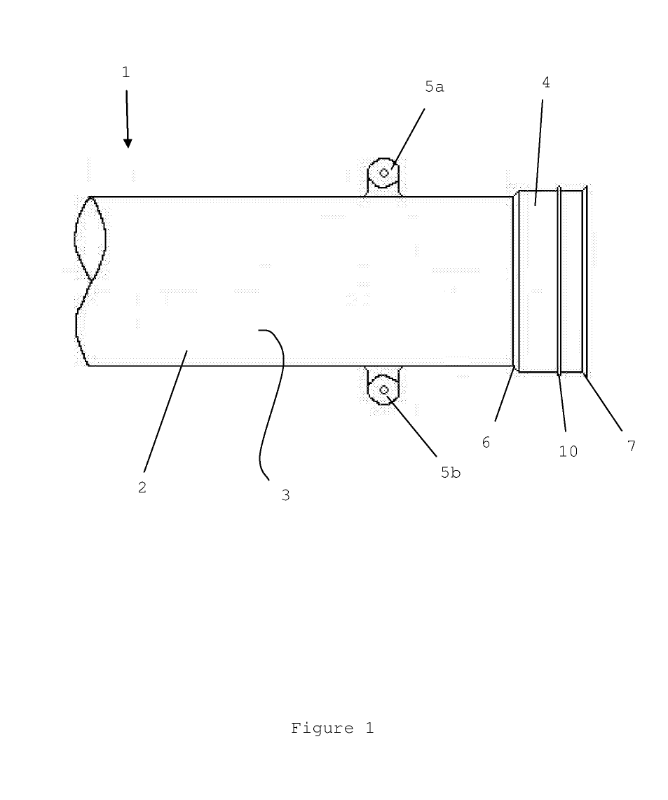

FIG. 1 shows a side view of a portion 2 of a composite material pipe 1 according to a first embodiment of the invention.

The pipe portion 2 is formed by filament winding of carbon fibre composite material and has an integral end fitting 4 on one end, with a slightly larger diameter of 3 inches (76 mm), than the rest 3 of the pipe portion 2. The pipe portion 2 also has two attachment points 5a, 5b used for attaching electrical bonding leads (not shown) to the pipe, for example in an aircraft.

The end fitting 4 comprises a pipe chamfered portion 6 where the end fitting 4 meets the rest 3 of the pipe portion 2. The end fitting 4 also has an end chamfered portion 7 at the far end of the end fitting 4.

The end fitting 4 is provided with an O-ring groove (22, although not labelled in FIG. 1 for clarity) with a compressive rubber O-ring 10 in it. The O-ring 10 and groove extend around the circumference of the end fitting 4 at a location towards the far end of the end fitting 4.

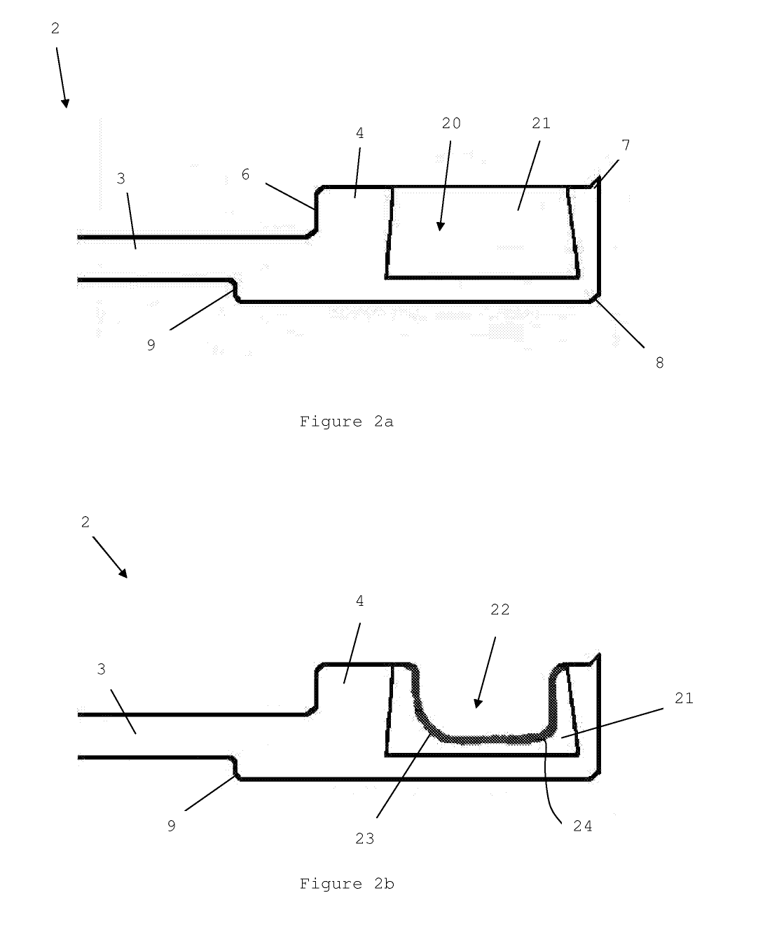

FIG. 2a shows an enlarged cross-sectional view of a channel 20 of the pipe portion 2 of FIG. 1, prior to formation of the O-ring groove 22. Here, the channel 20 is completely filled with epoxy resin 21. The channel 20 is machined with edges that taper inwards, so that the epoxy resin 21 is trapped and will not drop out when cured. In addition, tapered edges give more adhesive area for the resin 21 to adhere to than straight vertical edges. The channel has an equivalent diameter of less than 3.6 mm.

FIG. 2a also shows a step change 9 in the internal diameter of the pipe portion 2 and an internal chamfered portion 8 at the internal edge of the end of the end fitting 4.

FIG. 2b shows an enlarged cross-sectional view of the channel 20 of the pipe portion of FIG. 1, when the resin 21 has been partly ground down to leave the O-ring groove 22. It can be seen that the O-ring groove has rounded corners 23, 24 and provides a smooth groove for the O-ring 10. The O-ring groove 22 has an equivalent diameter of 3.5 mm. As can be seen, less than 1 mm of resin 21 (in the region of 0.010 to 0.020 inches (0.25 to 0.5 mm) is left in the channel 20. The corners 23, 24 have a radius of 1.6 mm and 0.5 mm respectively.

During manufacture of the pipe 1, carbon fibre composite material is filament wound to form the pipe 1, including the integral end fitting 4 and the rest 3 of the pipe. A channel 20 is then machined in the composite material of the end fitting 4. The channel is slightly deeper and wider than the O-ring groove 22 needs to be. This channel is filled completely with epoxy resin 21.

Once the resin 21 has cured, most of the resin is ground out and smoothed to form the required O-ring groove 22 with smooth corners 23, 24 and a good surface finish. An O-ring 10 is then placed inside the O-ring groove 22.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The invention is applicable to any size of pipe 1 or pipe portion 2. For example, the pipe 1 or pipe portion 2 may have a diameter of 0.5 to 5 inches (13 mm to 128 mm) or any other suitable dimension.

The O-ring groove 22 may have any suitable dimension, with regard to the size of O-ring 10 required. For example, the O-ring groove 22 could have a diameter of 3.5 mm or 4.75 mm, or any other suitable dimension.

The channel 20 may be made bigger than the O-ring groove 22 by any suitable dimension, but probably not more than 1 mm. For example, the channel 20 may be bigger than the O-ring groove 22 by 0.010 to 0.020 inches (0.25 to 0.5 mm).

The above example uses a composite material pipe 1. However, the use of a larger channel filled with resin and then ground down is equally applicable to metallic pipes.

The invention could be applied to many different fields. For example, it could be used in any pipe system where O-rings are required. For example, as well as being used in aircraft fuel pipes, the invention could be used in aircraft hydraulics, aircraft inerting system, aircraft pneumatics systems, possibly aircraft braking systems, petrochemical industry, refineries and nuclear reactors.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of manufacturing or repairing a pipe, the method comprising:
providing a pipe portion, wherein the pipe portion includes a channel along a surface of the pipe portion, and the channel includes an internal surface,
placing a filler material against the internal surface of the channel, and
removing at least some of the filler material to form a groove in the channel of the pipe portion.

2. The method of manufacturing or repairing a pipe as claimed in claim 1, wherein the channel extends at least partly around a circumference of the pipe portion.

3. The method of manufacturing or repairing a pipe as claimed in claim 2, wherein the groove in the channel is configured to accommodate an O-ring.

4. The method of manufacturing or repairing a pipe as claimed in claim 1, wherein the pipe portion is made from a composite material.

5. The method of manufacturing or repairing a pipe as claimed in claim 4, further comprising forming the composite material using filament winding.

6. The method of manufacturing or repairing a pipe as claimed in claim 1, wherein the pipe portion comprises an end fitting having a larger external diameter than a non-end region of the pipe and wherein the end fitting is integral with the pipe portion.

7. The method of manufacturing or repairing a pipe as claimed in claim 1, wherein the filler material is a curable material and wherein, after the filler material is placed against the internal surface of the channel, the method further comprises curing the filler material.

8. A method of manufacturing or repairing a pipe as claimed in claim 1, wherein the filler material is a resin.

9. The method of manufacturing or repairing a pipe as claimed in claim 1, further comprising applying the filler material to substantially cover an entire internal surface of the channel.

10. The method of manufacturing or repairing a pipe as claimed in claim 9, further comprising substantially completely filling the channel with the filler material.

11. The method of manufacturing or repairing a pipe as claimed in claim 1, wherein the removal includes removing by machining the filler material.

12. The method of manufacturing or repairing a pipe as claimed in claim 1, wherein the method further comprises inserting an O-ring in the groove.

13. The method of manufacturing or repairing a pipe as claimed in claim 1, wherein the channel has a diameter in a range of between 2 mm to 6 mm.

14. The method of manufacturing or repairing a pipe as claimed in claim 1, wherein the channel has inwardly angled edges.

15. The method of manufacturing or repairing a pipe as claimed in claim 1, wherein, after removal of the filler material, the remaining filler material has a thickness of less than 1 mm.

16. (canceled)

17. A pipe portion comprising:
a channel running along an external surface of the pipe portion, and the channel includes an internal surface,
a layer of filler material against the internal surface of the channel, and
a groove in the layer of filler material inside in the channel of the pipe portion.

18. A pipe comprising the pipe portion of claim 17.

19. The pipe portion as claimed in claim 17, wherein the pipe portion is configured for an aircraft fuel, pneumatic or inerting system.

20. An aircraft comprising the pipe portion according to claim 17.

21. A method of manufacturing or repairing a pipe, the method comprising providing a pipe portion formed of a composite material, wherein the pipe portion comprises an end fitting having a larger external diameter than a non-end region of the pipe portion and wherein the end fitting is integral with the non-end region of the pipe portion.

22. The method of manufacturing or repairing a pipe as claimed in claim 21, further comprising forming the pipe portion using a filament winding.

23. (canceled)

24. A pipe portion formed of a composite material, wherein the pipe portion comprises an end fitting having a larger external diameter than a non-end region of the pipe portion and wherein the end fitting is integral with the non-end region of the pipe portion.

25. The pipe portion as claimed in claim 24, wherein the composite material pipe portion includes filament winding.

26. A pipe comprising the pipe portion of claim.

27. The pipe portion as claimed in claim 24 configured for a pipe system in an aircraft fuel, pneumatic or inerting system.

28. An aircraft comprising a pipe or pipe portion according to claim 24.
